(19) United States
(12) Patent Application Publication
(10) Pub. No.: US 2008/0007266 A1
(43) Pub. Date: Jan. 10, 2008

(54) Engine abnormal condition detecting device

(75) Inventors: Mitsuyasu Enomoto, Anjo-city (JP); Kouji Andoh, Motosu-city (JP); Eiji Takakuwa, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/819,212

(22) Filed: Jun. 26, 2007

(30) Foreign Application Priority Data
Jul. 6, 2006 (JP) 2006-186457
Feb. 28, 2007 (JP) 2007-49706

(51) Int. Cl. F02P 17/12; F02B 77/08

(52) U.S. Cl. 324/380; 73/35.01

(57) ABSTRACT

In an ignition system that includes an ignition coil having a primary coil and a secondary coil, a switching element connected between the primary coil and a ground, a battery and a spark plug connected to one end of the secondary coil, an engine abnormal condition detecting device includes a Zener diode connected between the other end of the secondary coil and the ground to allow secondary current flowing in the secondary coil toward the ground, a resistor connected between the secondary coil and the ground to limit the secondary current flowing through the secondary coil to a preset level, a secondary current detecting circuit for detecting an amount of secondary current flowing through the resistor, and an electronic control circuit for determining an abnormal condition of the ignition system with reference to the amount of the secondary current flowing through the resistor.

### CROSS REFERENCE TO RELATED APPLICATION

The present application is based on and claims priority from Japanese Patent Applications: 2006-186457, filed Jul. 6, 2006; and 2007-49706, filed Feb. 28, 2007, the contents of which are incorporated herein by reference.

### BACKGROUND OF THE INVENTION

1. Field of the Invention

The present invention relates to an abnormal condition detecting device of an internal combustion engine.

2. Description of the Related Art

In an engine ignition system such as disclosed in JP-2001-271699A, an amount of primary current is supplied to the primary coil of an ignition coil so as to generate a high-voltage electric power at the secondary coil of the ignition coil by cutting supply of the primary current, thereby providing an ignition spark at a spark plug. In this device, a resistor is connected in series with the secondary coil to detect the amount of discharging current flowing across the electrodes of the spark plug, thereby detecting an abnormal condition of the spark plug such as a sooted surface thereof.

When the primary current is supplied to the primary coil of the ignition coil in the above-stated ignition system, a high voltage is induced in the secondary coil. The high voltage may cause an abnormal electric discharge across the electrodes of the spark plug at a timing other than the normal ignition timing.

### SUMMARY OF THE INVENTION

Therefore, an object of the invention is to provide an abnormal condition detecting device that can detect such an abnormal electric discharge at the spark plug.

According to an aspect of the invention an engine abnormal condition detecting device of an ignition system includes a current limiting element connected between a low voltage end of the secondary coil of an ignition coil and a ground, a secondary current detecting circuit for detecting an amount of secondary current; and means for determining an abnormal condition of the ignition system according to the amount of the secondary current.

Therefore, the voltage level of the secondary voltage that is induced in the secondary coil when the primary coil is supplied with primary current can be effectively controlled.

The above embodiment may further include a diode connected between the other end of the secondary coil and a ground so as to allow secondary current to flow from the other end of the secondary coil toward the ground and to prevent the secondary current to flow from the ground to the other end of the secondary coil.

In the above embodiment:

the means for determining an abnormal condition may determine an abnormal condition by the amount of the secondary current that flows through the secondary coil when primary current flows through the primary coil, that the spark plug has a sooted surface if the amount of the secondary current becomes larger than a threshold value for a continuance period after primary current starts flowing through the primary coil or that there is a preignition if the amount of the secondary current becomes larger than a threshold value (ia) for a period (tz) just before the primary current is interrupted by the switching element (20) at a normal ignition timing;

the diode may be a Zener diode or connected in parallel with the current limiting element;

the current limiting element may be connected between the secondary coil and the secondary current detecting circuit or may include a resistor that has a resistance of about 100 kΩ or larger than 100 kΩ.

According to another aspect of the invention, an engine abnormal condition detecting device of an ignition system includes a Zener diode connected between the low voltage end of the secondary coil and the ground to allow secondary current flowing in the secondary coil toward the ground, a resistor connected between the secondary coil and the ground to limit the secondary current flowing through the secondary coil to a preset level, a secondary current detecting circuit for detecting an amount of secondary current flowing through the resistor, and an electronic control circuit for determining an abnormal condition of the ignition system with reference to the amount of the secondary current flowing through the resistor (R).

According to another aspect of the invention, an engine abnormal condition detecting device of an ignition system includes a current limiting circuit connected between the low voltage end of the secondary coil and the ground to allow secondary current flowing in one direction and limit the secondary current flowing in the other direction to a preset level, a secondary current detecting circuit for detecting an amount of secondary current flowing through the current limiting circuit and an electronic control circuit for determining an abnormal condition of the ignition system with reference to the amount of the secondary current flowing through the current limiting circuit.

In the above engine abnormal condition detecting device, the current limiting circuit may include a Zener diode (ZD) and a resistor (R) that are connected in parallel with each other.

### BRIEF DESCRIPTION OF THE DRAWINGS

Other objects, features and characteristics of the present invention as well as the functions of related parts of the present invention will become clear from a study of the following detailed description, the appended claims and the drawings. In the drawings:

FIG. 1 is a block diagram of an ignition system for an internal combustion engine that includes an abnormal condition detecting device according to a preferred embodiment of the invention;

FIG. 2 is a time diagram showing time relation among an ignition signal, a secondary voltage wave and a secondary current wave;

FIG. 3 is a flow diagram of the operation of the abnormal condition detecting device shown in FIG. 1;

FIG. 4 is a time diagram showing relation among an ignition signal, a secondary voltage wave and a secondary current wave when an abnormal condition takes place;

FIG. 5 is a time diagram showing relation among an ignition signal, a secondary voltage wave and a secondary current wave when an abnormal condition takes place; and

FIG. 6 is a block diagram of an ignition system for an internal combustion engine that includes a variation of the abnormal condition detecting device according to a preferred embodiment of the invention.

### DETAILED DESCRIPTION OF THE PREFERRED EMBODIMENTS

An engine abnormal condition detecting device according to a preferred embodiment of the present invention will be described with reference to the appended drawings.

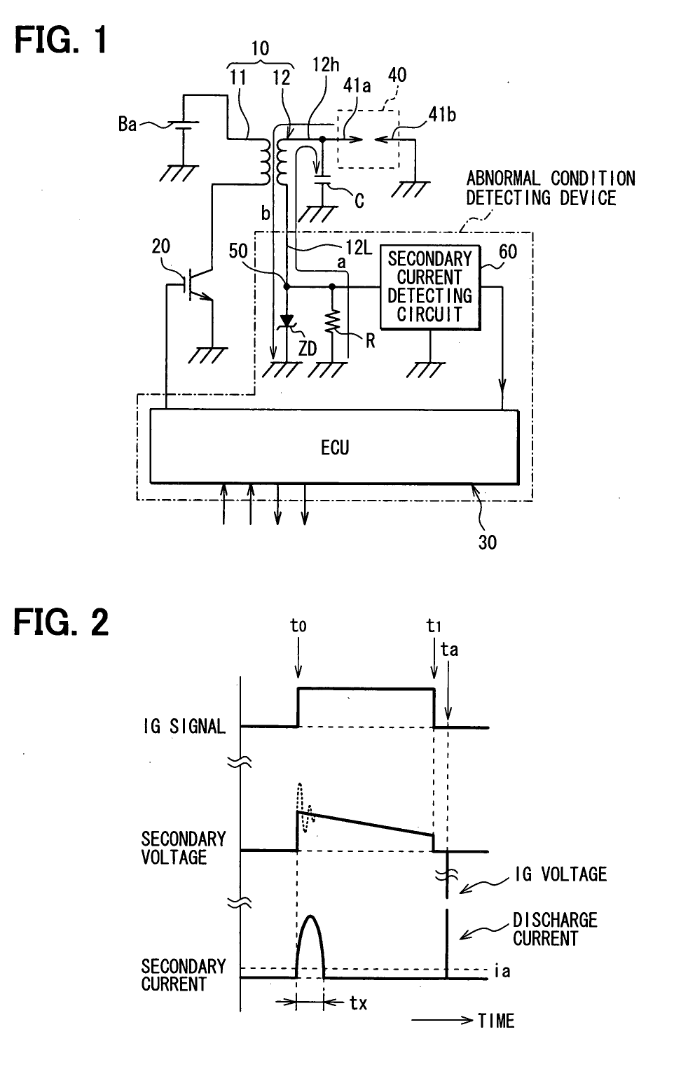

As shown in FIG. 1, an ignition system includes an ignition coil 10, an insulated gate bipolar transistor (hereinafter referred to as IGBT) 20, an electronic control unit (hereinafter referred to as ECU) 30, a spark plug 40, a secondary current detecting circuit 60, a battery Ba, a Zener diode ZD, a resistor R, etc. An engine abnormal condition detecting device is constructed of ECU 30, the secondary current detecting circuit 60, the Zener diode ZD, and the resistor R.

The ignition coil 10 includes a primary coil 11 and a secondary coil 12. The primary coil 11 has one end connected with the positive terminal of the battery Ba that is mounted in a vehicle and the other end connected with a ground via IGBT 20. The switching operation of IGBT 20 is controlled by ECU 30. The secondary coil 12 has a high voltage end 12h connected to a center electrode 41a of the spark plug 40 and a low voltage end 12L connected to the ground via the Zener diode ZD. The spark plug 40 also has a ground electrode 41b disposed at a certain distance from the center electrode 41a. The Zener diode ZD controls the level of the secondary voltage induced in the secondary coil 12. The resistor R has a resistance of 100 kΩ or higher and is connected in parallel with the Zener diode ZD so as to detect an abnormal condition of the ignition system, such as preignition.

The secondary current detecting circuit 60 is connected between the resistor R on the side of the cathode of the Zener diode ZD and ECU 30 to provide the latter with a signal that is amplified voltage drop of the resistor R.

ECU 30 is constructed of a microcomputer, memories, timers etc. ECU 30 controls control IGBT 20 thereby controlling ignition timing and detects an abnormal condition, such as preignition, sooted surface of the spark plug, or ignition coil failure. Incidentally, the spark plug 40, the resistor R and the Zener diode ZD are provided with for each cylinder of the engine.

The operation of the ignition system will be described with reference to FIGS. 2-5.

When ECU 30 sends IGBT 20 an ignition signal to turn on at time t₀, primary current flows through the primary coil 11. Consequently, secondary voltage is induced in the secondary coil 12, as shown in FIG. 2. Incidentally, when IGBT 20 turns on at time t₀, the high voltage end 12h of the secondary coil 12 becomes positive. Because a stray capacitance C is formed between the high voltage end 12h and the ground, secondary current that flows through the secondary coil 12 charges the stray capacitance C at first. Consequently, the secondary current flows from the ground through the resistor R toward the low voltage terminal 12L of the secondary coil 12, as indicated by an arrow a as shown in FIG. 1.

If the amount of the secondary current becomes larger, the peak of the secondary voltage increases, as indicated by a dotted line in FIG. 2, to a level that causes an ignition spark. The resistor R, whose resistance is 100 kΩ or higher, controls the level of the peak as indicated by a solid line.

When ECU 30 turns off IGBT 20 at time t₁, flow of the primary current is interrupted. Consequently, a negative high voltage appears at the high voltage end 12h of the secondary coil 12 at time ta, so that an ignition spark is generated between the center electrode 41a of the spark plug 40 and the ground electrode 41b thereof.

In this moment, discharge current flows from the high voltage end 12L of the secondary coil 12 via the low voltage end 12L thereof and the Zener diode ZD toward the ground, as indicated by an arrow b in FIG. 1. Therefore, the Zener diode ZD prevents energy loss of the ignition power by bypassing the resistor R.

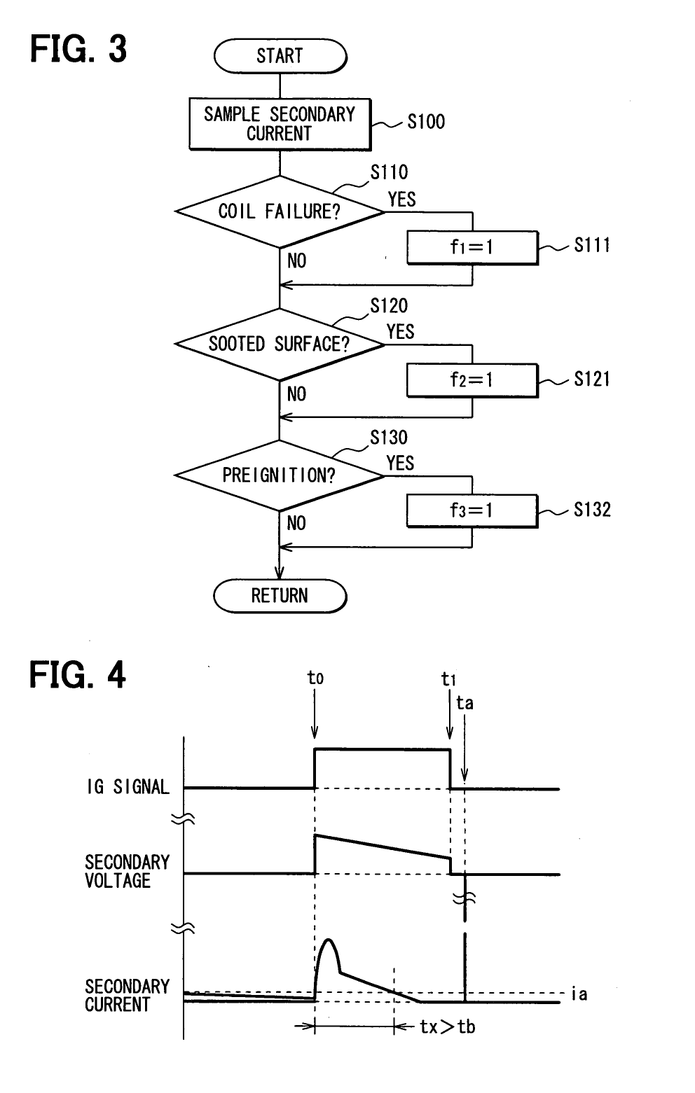

Abnormal conditions of the ignition system are detected by the engine abnormal condition detecting device in the manner shown in a flow diagram in FIG. 3.

At first, the signal outputted by the secondary current detecting circuit 60 is sampled for a fixed period at step S100, and whether a failure of the ignition coil exists or not is examined at S10. This is carried out by examining whether the amount of the secondary current is higher than a threshold value ia or not for a continuance period tx after the IGBT 20 turns on. If the continuance period tx is shorter than a first threshold value Ta, it is determined that the ignition coil 10 has a broken wire. In this case, YES is provided at S110, and a flag f1 is set as f1=1 at S111. If the continuance period tx is not shorter than the threshold value Ta on the other hand, NO is provided at S110 to be followed by S120, where whether a sooted surface of the spark plug 40 exists or not is examined. Incidentally, the sooted surface may be formed if the spark plug is soaked with an amount of unburned liquid fuel. If the continuance period tx is equal to or longer than a second threshold value Tb that is larger than Ta, it is determined that a sooted surface of the spark plug exists. Consequently, YES is provided to be followed by S121, where a failure-notice flag 2 is set as f2=1.

Incidentally, if the continuance period tx is longer than the first threshold value Ta but shorter than the second threshold value Tb ( i.e. Ta<tx<Tb), it is determined that the spark plug 40 has no sooted surface and that the ignition coil 10 has no broken wire.

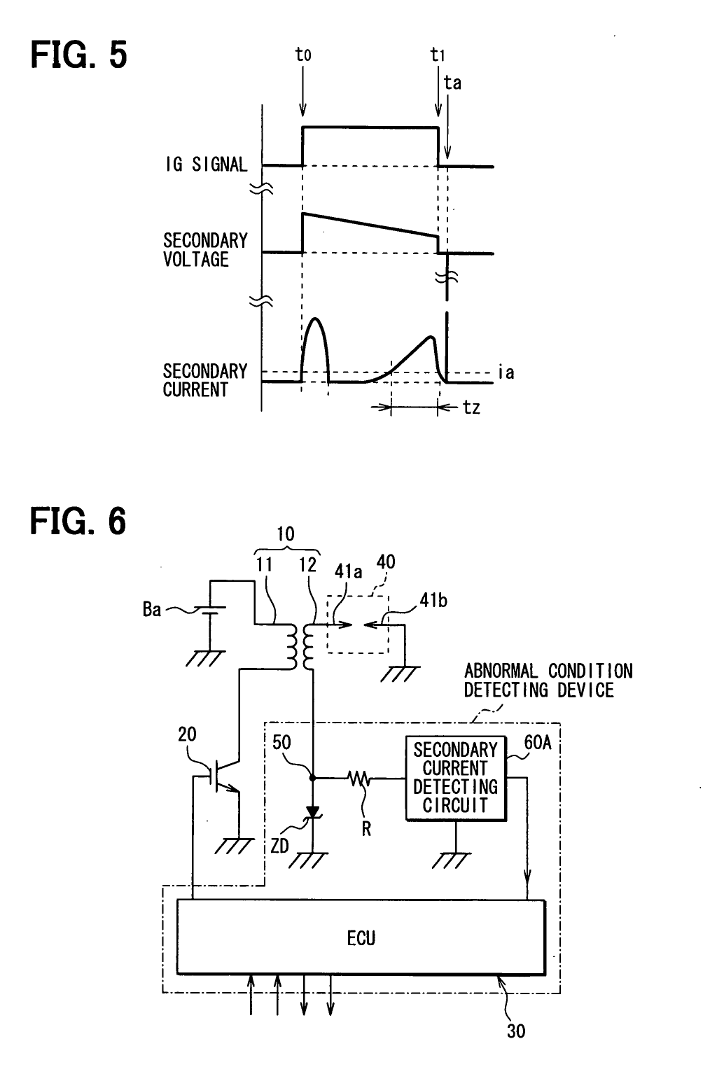

In the next step 130, whether a preignition takes place or not is examined. As shown in FIG. 5, if the amount of the secondary current is larger than a threshold value ia in a period tz just before t1 when the primary current is interrupted, it is determined that a preignition takes place. Consequently, YES is provided there and a failure-notice flag 3 is set as f3=1 at S131. Incidentally, the step S130 will not provide YES if the amount of the secondary current flowing after the time t₀ is continuously larger than the threshold level ia even in the period Tz, as it is considered that a spark plug has a sooted surface.

Thereafter, the step returns to sample the signal outputted by the secondary current detecting circuit 60 at S100, examine whether a failure of the ignition coil exists or not at S110, examine whether a sooted surface of the spark plug 40 exists or not at S120, and examine whether a preignition takes place or not at 130. These steps are carried out repeatedly.

Incidentally, the resistor R may be connected between the cathode of the Zener diode ZD and a secondary current detecting circuit 60A so that the secondary current detecting circuit 60A directly detects the secondary coil, as shown in FIG. 6.

In the foregoing description of the present invention, the invention has been disclosed with reference to specific embodiments thereof. It will, however, be evident that various modifications and changes may be made to the specific embodiments of the present invention without departing from the scope of the invention as set forth in the appended claims. Accordingly, the description of the present invention is to be regarded in an illustrative, rather than a restrictive, sense.

What is claimed is:

1. An engine abnormal condition detecting device of an ignition system that includes an ignition coil having a primary coil and a secondary coil, a battery, a switching element connected in series with the battery and the primary coil, and a spark plug connected to an end of the secondary coil, said engine abnormal condition detecting device comprising:
a current limiting element connected between the other end of the secondary coil and the ground;
a secondary current detecting circuit for detecting an amount of secondary current; and
means for determining an abnormal condition of the ignition system according to the amount of the secondary current,
wherein the current limiting element comprises a resistor that has a resistance of about 100 kΩ or larger than 100 kΩ.

2. An engine abnormal condition detecting device as in claim 1, further comprising a diode connected between the other end of the secondary coil and a ground so, as to allow secondary current to flow from the other end of the secondary coil toward the ground and to prevent the secondary current to flow from the ground to the other end of the secondary coil.

3. An engine abnormal condition detecting device as in claim 1, wherein the means for determining an abnormal condition determines an abnormal condition by the amount of the secondary current that flows through the secondary coil when primary current flows through the primary coil.

4. An engine abnormal condition detecting device as in claim 1, wherein the means for determining an abnormal condition determines that the spark plug has a sooted surface if the amount of the secondary current becomes larger than a threshold value for a continuance period after primary current starts flowing through the primary coil.

5. An engine abnormal condition detecting device as in claim 1, wherein the means for determining an abnormal condition determines that there is a preignition if the amount of the secondary current becomes larger than a threshold value for a period just before the primary current is interrupted by the switching element at a normal ignition timing.

6. An engine abnormal condition detecting device as in claim 1, wherein:
the diode is connected in parallel with the current limiting element.

7. An engine abnormal condition detecting device as in claim 1, wherein:
the current limiting element is connected between the secondary coil and the secondary current detecting circuit.

8. An engine abnormal condition detecting device as in claim 1, wherein the diode comprises a Zener diode.

9. An engine abnormal condition detecting device of an ignition system that includes an ignition coil having a primary coil and a secondary coil, a switching element connected between the primary coil and a ground, a battery and a spark plug connected to one end of the secondary coil, said engine abnormal condition detecting device comprising:
a Zener diode connected between the other end of the secondary coil and the ground to allow secondary current flowing in the secondary coil toward the ground;
a resistor connected between the secondary coil and the ground to limit the secondary current flowing through the secondary coil;
a secondary current detecting circuit for detecting an amount of secondary current flowing through the resistor; and
an electronic control circuit for determining an abnormal condition of the ignition system with reference to the amount of the secondary current flowing through the resistor.

10. An engine abnormal condition detecting device of an ignition system that includes an ignition coil having a primary coil and a secondary coil, a switching element connected between the primary coil and a ground, a battery and a spark plug connected to one end of the secondary coil, said engine abnormal condition detecting device comprising:
a current limiting circuit connected between the other end of the secondary coil and the ground to allow secondary current flowing in one direction and limit the secondary current flowing in the other direction to a preset level;
a secondary current. detecting circuit for detecting an amount of secondary current flowing through the current limiting circuit; and
an electronic control circuit for determining an abnormal condition of the ignition system with reference to the amount of the secondary current flowing through the current limiting circuit.

11. An engine abnormal condition detecting device as in claim 11, wherein the current limiting circuit comprises a Zener diode and a resistor (R) that are connected in parallel with each other.
